(19) United States
(12) Patent Application Publication
(10) Pub. No.: US 2007/0067238 A1
(43) Pub. Date: Mar. 22, 2007

(54) System and method for transferring information between financial accounts

(75) Inventors: Jeremy K. Rabson, Newton, MA (US); Roy E. Lowrance, Washington, DC (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: CAPITAL ONE FINANCIAL CORPORATION

(21) Appl. No.: 11/232,408

(22) Filed: Sep. 21, 2005

(51) Int. Cl. G06Q 40/00

(52) U.S. Cl. 705/40

(57) ABSTRACT

Systems and methods are provided to transfer account information from one application to another application. An example involves using a data extraction routine to access a customer electronic payment account at a first entity, obtain data associated therewith, and transfer the information to a new electronic payment account a second entity. The customer may provide the second entity with access information to enable the first entity to access the customer's account with the first entity.

### TECHNICAL FIELD

This invention relates in general to transfer information between financial accounts. More particularly, in certain embodiments, the invention relates to transferring online banking information from an account at a financial institution to an account at another financial institution.

### BACKGROUND

Consumers maintain financial accounts for a variety of purposes. Financial accounts can include, for example, credit accounts, savings accounts, checking accounts, investment accounts. Certain accounts are commonly used to pay bills. Bills may be paid online. In certain situations, an online payment is made through a web interface available on a web site operated by the service provider that issues the invoice or bill. In other situations, a bank may provide an online payment system allowing customers to pay bills to a variety of services providers.

### SUMMARY

Certain embodiments of the present invention are generally directed to systems and methods for switching an online payment service from one provider to another. Among other things, the second provider may obtain approval from the customer wishing to make the switch. The second provider may also obtain certain information to access the customer's online payment account within the online system of the first provider. The second provider may then lift the customer's online payment from the first online payment system by, for example, executing a screen scraping application. The lifted information is used to establish the second online payment account at the second institution.

According to one embodiment, a system is provided for establishing an electronic payment account. The system includes a processor and an electronic payment account information transfer application executable by the processor. The transfer application is operable to access an electronic payment application at a first provider. The transfer application is further operable to execute a data extraction routine to extract data from the first electronic payment application. The data is associated with a first electronic payment account. The transfer application is further operable to insert the data into a second electronic payment account.

According to another embodiment, a method is provided for establishing an electronic payment account. One step includes accessing a first electronic payment application. Another step is using a data extraction routine to obtain electronic payment information from the first electronic payment application. Still another step is transferring the information to a second electronic payment application.

Certain embodiments may benefit from certain advantages. It should be noted that any particular embodiment may provide some, none, or all of the listed advantages.

One advantage is that the process of switching between online payment providers may be automated. This enables a customer to make the switch without having to completely repeat the process used in establishing the first account. The switch may be made through the use of computers and software applications. This speeds the process of establishing the second online payment account and deactivation of the first online payment account.

Another advantage of the automated nature of the transfer of information between the first system and the second system is that errors are reduced with respect to the establishment of information in the second system. For example, service provider account numbers may be automatically transferred. This reduces the chance that the account numbers will be entered (e.g., by keyboard) incorrectly in the second system.

Another advantage is that payment activity is not disrupted. Due to the ease and speed by which the online bill payment service may be switched, the time to terminate one online payment account and establish a second online payment account is greatly reduced. Thus, bills may continue to be paid to the correct entities without disruption or delay, which, in turn, can cause late payment issues.

Another advantage is that an online payment account may be created and data fields may be populated without having to re-enter the data. This saves time and reduces errors.

Other advantages will be apparent from a review of the detailed description, the drawings and the appended claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for enabling the transfer of information from a first online payment account to a second online payment account in accordance with an embodiment of the invention; and

FIG. 2 illustrates an example method of transferring information from a first online payment account to a second online payment account in accordance with an embodiment of the invention.

### DETAILED DESCRIPTION

Embodiments of the present invention are generally directed to switching between online services such as, for example, online bill payment services. A consumer, for example, may desire to make the switch from one financial institution to another. The consumer may give access information to the second institution allowing the second institution to access the consumer's account at the first institution. The second institution may execute a data retrieval application to lift information from a graphical user interface associated with the consumer account at the first institution. The lifted information is used to populate the data fields associate with the new account at the second institution.

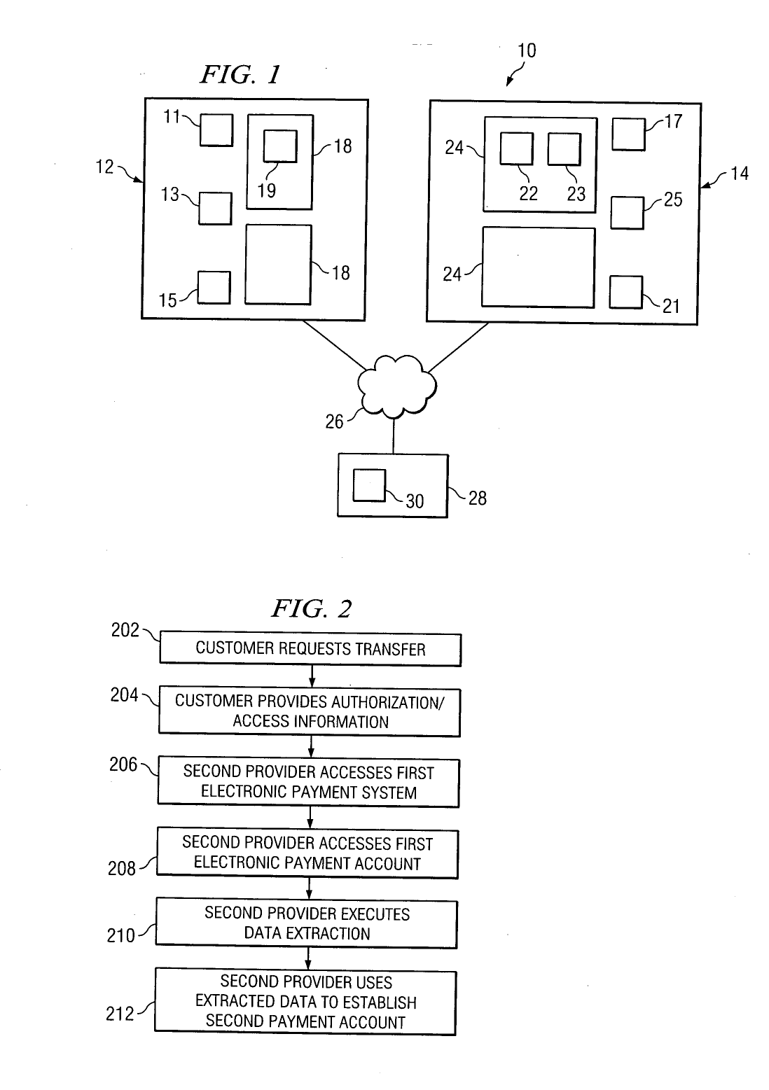

Example embodiments of the present invention and their advantages are best understood by referring now to FIGS. 1 and 2 of the drawings, in which like numerals refer to like parts. FIG. 1 illustrates an example system 10 of a first financial service provider 12 and a second financial service provider 14. System 10 may include additional financial service providers (not shown). “Financial service provider” is meant to include any entity that may provide electronic invoice payment functionality, such as online bill payment services. Thus, “financial service provider” may include entities such as banks, credit issuers, investment companies, etc. Merchants (and any other entity that provides goods or services in exchange for payment) are also included to the extent they provide the ability for customers to pay electronically. In the example embodiment, first and second financial service providers 12 and 14 are banks.

According to the illustrated embodiment, first provider 12 may include one or more operator terminals 11, a data management system 13, a network interface 15, and one or more function modules 18. Data management system 13 may include one or more processors and one or more databases for enabling one or more applications to be performed by the function modules 18. The components of first provider 12 may be located at one or more sites and may be coupled to each other using one or more links, each of which may include some or all of a computer bus, local area networks (LANs), metropolitan area networks (MANs), wide area networks (WANs), portions of the Internet, a public switched telephone network (PSTN), any other appropriate wireline, optical, wireless, or other suitable communication link, or any combination of the preceding.

An operator terminal 11 may provide an operator with access to data management system 13 to configure, manage, or otherwise interact with data management system 13. An operator terminal 11 may include a computer system. As used in this document, the term “computer” refers to any suitable device operable to accept input, process the input according to predefined rules, and produce output, for example, a personal computer, workstation, network computer, wireless data port, wireless telephone, personal digital assistant, one or more processors within these or other devices, or any other suitable processing device.

Data management system 13 may store various data and/or files regarding financial accounts maintained by first provider 12, such as the parameters, the relevant entities, the balance, and the account status of each account, for example. Data management system 13 may manage data associated with accounts stored in an account database, which may in particular embodiments include creating, modifying, and deleting data files associated with accounts automatically or in response to data received from the one or more operator terminals 11 function modules 18, the accounts themselves, and/or the account holders. These activities may specifically include querying a balance, automatically transferring funds, extending credit, changing account parameters such as an interest rate, etc. Additionally, data management system 13 may call the one or more function modules 18 to provide particular functionality according to particular needs, as described more fully below. Data management system 13 may include one or more data processing units, one or more memory units, one or more web servers, and any other suitable components for managing data associated with accounts. The components of data management system 13 may be supported by one or more computer systems at one or more sites. One or more components of data management system 13 may be separate from other components of data management system 13, and one or more suitable components of data management system 13 may, where appropriate, be incorporated into one or more other suitable components of data management system 13. The term “accounts” includes any account from which payments may be made. Examples include, credit accounts, savings accounts, investment accounts, and checking accounts.

The one or more data processing units may process data associated with the accounts, which may include executing coded instructions that may in particular embodiments be associated with the one or more function modules 18. The one or more memory units may be coupled to the data processing unit(s) and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors. The memory unit(s) may be separate from or partially or completely integrated with an account database.

A network interface 15 may provide an interface between data management system 13 and a communications network 26 such that data management system 13 may communicate with account holders, such as customer 28, and with other financial service providers, such as second financial service provider 14.

A function module 18 may provide particular functionality associated with handling accounts or handling transactions in which money is transferred between accounts. As an example only and not by way of limitation, a function module 18 may provide functionality associated with establishing and managing accounts, risk profiling, and records management. A function module 18 may be called by data management system 13, for example, as a result of data received from an operator terminal 11, an account, or an account holder. This data may be received via communications network 26. In response, the function module 18 may provide the particular functionality associated with the function module 18 and communicate one or more results to a data processing unit or one or more other suitable components of data management system 13. The communicated results may be used to create, modify, or delete one or more data files associated with one or more accounts, provide data to an operator at an operator terminal 11, or perform any other suitable task. It should be understood that data being transmitted over communications network 26 or among any of the components of system 10 (e.g., electronic payment information) may be transmitted via any suitable method including telephonically, digitally, by way of a voice recognition unit (VRU), orally, etc.

Function modules 18 are operable to perform various functions in the operation of the system 10. According to one embodiment, a function module 18 includes an electronic payment application 19. Application 19 allows a customer to pay for an invoice electronically. For example, application 19 may provide online payment functionality to allow the customer may to access application 19 online via the Internet and use application 19 to pay a variety of bills. In some configurations, the customer accesses an electronic payment function provided by a service provider that has also issued the invoice. In this embodiment, the customer accesses the electronic payment function to pay bills to a single debtor, merchant, service provider etc. The customer may be able to pay multiple bills, but only those issued by the provider. For example, if the service provider is an electric utility company, the customer may be able to access the company's electronic payment function to pay multiple electric bills all issued by the same company. In other configurations, the electronic payment application is provided by a third party, such as a bank, other financial institution, or electronic payment application provider. For example, a bank may make an electronic payment application available to its customers to enable them to pay a variety of bills issued by a variety of merchants, services providers, other financial institutions, etc.

In at least one embodiment, the electronic payment application is provided in the form of an online bill payment system. Preferably, the online bill payment function is provided by way of a graphical user interface (GUI), which provides an interface by which the customer may make various selections in order to accomplish invoice payment. For example, the online payment GUI may provide the customer to select from a plurality of bill payment recipients. In the case of a single provider, this may be predetermined. In the case of other online payment scenarios (as discussed above), however, the customer may be able to select from among a variety of merchants, service providers, etc (invoice or bill issuing entities), in order to make payments on invoices from the respective entities. The GUI may also allow the customer to provide certain payment information, such as account numbers, codes, expiration dates, customer identity codes, merchant identity codes, or other information, addresses, telephone numbers, etc. The GUI may also enable the customer to select a payment amount. The GUI may also enable the customer to select from various invoices or bills. The GUI may also allow the customer to provide a payment execution date, which may be different (for instance) from the date on which the customer is providing the information. The GUI preferably allows these and other functions which may be associated with an electronic and/or online payment service.

Like data management system 13, function modules 18 may be physically distributed such that each function module 18 or multiple instances of each function module 18 may be located in a different physical location geographically remote from each other, from data management system 13, or both. In addition, each function module 18 may be partially or completely integrated with other function modules 18 and/or with other components of first provider 12. For example, particular function modules 18 may include operator terminals 11 such that at least a portion of the functionality of such function modules 18 is provided by human operators. Thus it should be understood that the functionality provided by each of function modules 18 may be completely automated, partially automated, or completely human-controlled.

FIG. 1 also illustrates a second financial services provider 14. Similar to first provider 12, second provider 14 has one or more operator terminals 17, a data management system 25, and a network interface 21. Network interface 21 allows electronic communications among the components of second provider 14 and with the other elements of system 10, via communications network 26. Second provider also includes one or more function modules 24. Functions modules 24 provide functionality for second provider 14 similar to that provided by function modules 18 for first provider 12. One of the function modules 24 includes an electronic payment application 22 similar to that described above in connection with first provider 12.

This particular function module (or another function module or component of second provider 14) includes an electronic payment system information transfer application 23. Application 23 enables the transfer of information from first electronic payment application 19 to second electronic payment application 22. Among other things, in certain embodiments, this transfer allows a customer 28 to terminate first payment application 19 and automatically establish second payment application 22. This may be accomplished simultaneously or nearly simultaneously.

Preferably, transfer application 23 automatically lifts the information and data from first payment application 19 and deposits the information in the appropriate data fields, records, etc. necessary to establish the electronic payment functionality of second payment application 22. For example, customer 28 may have an electronic payment account with first payment provider 12, which allows customer 28 to pay bills online (e.g., using computer 30 connected to the Internet). The payment account may have a variety of merchants which are either predetermined or customized by customer 28. For each merchant, invoice information may be periodically loaded into a payment due field within the electronic payment application. This information may be provided, for example, from the merchant to the provider 12 by way of an electronic communication at the customer's request. For instance, the customer may provide financial institution information (such as routing and account numbers) to the merchant and may otherwise request the merchant to establish a relationship first provider 12 in order to electronically receive payments from provider 12 using an account owned by customer 28. For each merchant included in the electronic payment account, there may be other information available on a permanent, temporary, or periodic basis. For example, the customer may be able to specify a payment date as the date on which the payment to the particular merchant will be made. The customer may specify a payment amount, an account from which a payment will be made, and other parameters associated with electronic payments such as whether a payment is a one-time payment or a periodic payment. Other parameters of electronic payment systems are envisioned and included within the scope and spirit of the disclosure.

The transfer of information from one electronic payment system to another may be accomplished, for example, by the use of a data extraction application. The term “data extraction application” is meant to encompass any technique by which data may be identified and removed from a medium. Other terms that may be used include, without limitation, screen scraping, web scraping, data scraping, page scraping, and HTML (Hypertext Markup Language) scraping. Accordingly, according to an example embodiment, the data extraction application is operable to capture data from a system or program by capturing and interpreting the contents of an associated display that is not actually intended for data transport or inspection by programs. Data extraction, in certain scenarios, can refer to parsing HTML in web pages with computer programs designed to find particular patterns or parts of content. Screen scraping may be accomplished, for example, by the use of regular expressions or computer languages that have strong support for regular expressions.

Preferably, the data extraction tool also includes, or is accompanied by, a data insertion tool operable to take the data extracted from the first payment system and insert it into the appropriate locations within the second payment system. Alternatively, the transfer application may simply copy the first payment system application along with the data for the particular customer wanting the transfer and duplicate the entire package of information within the system of the second provider.

FIG. 2 illustrates an example method of effecting the transfer of information within a first electronic payment system of a first financial services provider to a second electronic payment system of a second financial provider. At step 202, a transfer is initiated. This can be accomplished, for example, by customer 28 requesting the second provider to establish the second electronic payment account. The request can be made by any suitable method including oral or electronic instructions. Step 202 encompasses the second provider receiving the request or initiating a transfer itself.

At step 204, the customer may provide (and/or the second provider may receive or retrieve) certain access data to enable the second provider to access the first electronic payment account that the customer has with the first provider. Information received from the customer may be processed and/or added to additional data to create the data set necessary for accessing the first electronic payment account.

At step 206, the second provider accesses the first electronic payment system at the first provider via, for example, the communications network referred to above in connection with FIG. 1. This can be accomplished in the same way that the customer would access the first electronic payment system. Alternatively, the transfer application of the second provider may automatically access the first electronic payment application.

At step 208, the transfer application uses the customer access data, and accesses the customer's electronic payment account within the payment application of the first provider. For example, the second provider may log on to an interface, such as a web interface, as the customer.

At step 210, the transfer application executes a data extraction routine to identify data necessary for transfer to a second electronic payment account. The data being extracted can include any data necessary to, or helpful in, establishing the new electronic payment account at the second institution. This can include, without limitation, merchant identification data, payment information and parameters, and any of the other types of information discussed above in connection with FIG. 1. Data extraction may be performed by any suitable technique including, without limitation, screen scraping or any of the other techniques discussed above in connection with FIG. 1.

At step 212, the transfer application inserts that extracted data into a second electronic payment account within the second payment application of the second provider. Again, any suitable data insertion technique may be employed. The extracted and transferred data is used to establish the new electronic payment account.

Certain additional steps (not expressly shown) may also be included. For example, the entity establishing the second electronic payment account may execute an account confirmation step to confirm the accuracy of payment information in the second account. This may be accomplished by a manual or electronic comparison of the data fields in the first electronic payment application and the second electronic payment application. The confirmation step may also involve sending an electronic or hard copy version of the second electronic payment account parameters to the customer to obtain approval of the transfer.

An additional step may include monitoring un-cleared payments (e.g., payments made by check, or electronic payments set up for an execution date later than the date the electronic payment was initiated). This monitoring function may be used to ensure that a payment was in fact made to the respective bill issuer (e.g., merchant). If a payment was not made, the entity managing the second account may prompt the customer to make a payment to the bill issuer. If the payment was made, the entity managing the second account may use this information to ensure that duplicate payments are not made. One objective of this scenario is to ensure uninterrupted and non-redundant payment of invoices during the transition.

Another additional step may include sending notifications of the transfer. Notifications may be sent, for example, to the customer, to the entity managing the first electronic payment account, and/or to merchants receiving payments via the first electronic payment account.

Another step may include altering existing automatic deposit information of the customer such that automatic deposits are made to a new financial account associated with the second electronic payment account.

Modifications, additions, or omissions may be made to the method without departing from the scope of the invention. Additionally, steps may be performed in any suitable order without departing from the scope of the invention.

Although an embodiment of the invention and its advantages are described in detail, a person skilled in the art could make various alterations, additions, and omissions without departing from the spirit and scope of the present invention as defined by the appended claims.

1. A system for establishing an electronic payment account, comprising:
a processor; and
an electronic payment account information transfer application executable by the processor, the transfer application operable to access an electronic payment application at a first provider, execute a data extraction routine to extract data from the first electronic payment application, the data associated with a first electronic payment account, and further operable to insert the data into a second electronic payment account.

2. The system of claim 1, further comprising an interface operable to receive access information for accessing the first electronic payment application.

3. The system of claim 2, wherein the access information is received from a customer requesting the establishment of the second electronic payment account.

4. The system of claim 1, further comprising a transfer authorization module operable to receive a transfer request and electronic payment account access information for the first electronic payment account.

5. The system of claim 4, wherein the transfer authorization module is integrated with the electronic payment account information transfer application.

6. The system of claim 4, wherein the transfer authorization module is further operable to receive transfer data from at least one billing entity associated with the first electronic payment application.

7. The system of claim 1, further comprising a second electronic payment application, the second electronic payment application comprising the second electronic payment account.

8. The system of claim 1, wherein the electronic payment account information transfer application is integrated with the second electronic payment application.

9. A method for establishing an electronic payment account, the method comprising:
accessing a first electronic payment application;
using a data extraction routine to obtain electronic payment information from the first electronic payment application; and
transferring the information to a second electronic payment application.

10. The method of claim 9, further comprising receiving a request from a customer to establish the electronic payment account.

11. The method of claim 9, wherein the customer has a pre-existing electronic payment account at a first provider and the request comprises a request to transfer information from the pre-existing account to a new electronic payment account.

12. The method of claim 9, further comprising receiving access information to enable an entity managing the electronic payment account to access the first electronic payment application.

13. The method of claim 12, wherein the access information enables the managing entity to access a first electronic payment account of the first electronic payment application.

14. The method of claim 9, wherein, for a given customer, the first electronic payment application provides an electronic payment relationship between the given customer and only one merchant.

15. The method of claim 14, wherein the first electronic payment application is managed by a merchant.

16. The method of claim 9, wherein, for a given customer, the first electronic payment application provides an electronic payment relationship between the given customer and a plurality of merchants.

17. The method of claim 16, wherein the first electronic payment application is managed by a financial institution.

18. The method of claim 9, wherein the electronic payment account is managed by a financial institution.

19. The method of claim 9, wherein the payment information comprises at least one invoice amount.

20. The method of claim 9, wherein the payment information comprises at least one merchant identification.

21. The method of claim 9, wherein the payment information comprises at least one payment execution time.

22. The method of claim 9, wherein the payment information comprises at least one account number associated with an account from which a payment will be made.

23. The method of claim 9, wherein the payment information comprises at least one payment due date.

24. The method of claim 9, further comprising receiving an authorization from at least one merchant to transfer payment information associated with the at least one merchant from the first electronic payment application to the second electronic payment application.

25. The method of claim 9, wherein the data extraction routine comprises a screen scraping application.

26. The method of claim 9, wherein the data extraction routine comprises a web scraping application.

27. The method of claim 9, wherein the data extraction routine comprises a page scraping application.

28. The method of claim 9, wherein the data extraction routine comprises an HTML scraping application.

29. The method of claim 9, wherein at least some electronic payment information is obtained using the data extraction routine and at least some electronic payment information is obtained using an manual process in which an operator views the information and enters the information into the second electronic payment application using an electronic data entry device.

30. The method of claim 9, wherein an entity managing the second electronic payment application obtains the electronic payment information directly from an entity managing the first electronic payment application.

31. The method of claim 9, wherein an entity managing the second electronic payment application obtains the electronic payment information indirectly from an entity managing the first electronic payment application, through electronic communication with a customer having an electronic payment account with the first electronic payment application.

32. The method of claim 9, wherein the step of obtaining electronic payment information comprises obtaining information from a customer computer.

33. The method of claim 9, wherein the step of obtaining electronic payment information comprises obtaining information from a financial institution computer.

34. The method of claim 9, wherein the step of obtaining electronic payment information comprises obtaining information from a merchant computer.

35. The method of claim 9, wherein electronic payment information from at least the first electronic payment application and at least a third electronic payment application is obtained and transferred to the second electronic payment application.
